(19) United States
(12) Patent Application Publication
(10) Pub. No.: US 2026/0102924 A1
(43) Pub. Date: Apr. 16, 2026

(54) SOLUTION OF UNDISRUPTED HUMAN-MACHINE WORKFLOW COUPLING BASED ON VARIABLE VIRTUAL FIXTURES

(71) Applicant: Zhejiang University, Hangzhou (CN)

(72) Inventors: Liangjing YANG, Hangzhou (CN); Yunze SHI, Hangzhou (CN); Tengyue WANG, Hangzhou (CN)

(73) Assignee: Zhejiang University, Hangzhou (CN)

(21) Appl. No.: 19/421,152

(22) Filed: Dec. 16, 2025

(30) Foreign Application Priority Data
Feb. 5, 2025 (CN) 202510130686.4

(51) Int. Cl. B25J 13/08; B25J 9/16

(52) U.S. Cl. CPC B25J 13/085; B25J 9/1689

(57) ABSTRACT

The invention discloses a method of undisrupted human-machine workflow coupling, including S1, dividing a workflow in a laboratory into manual operations and automated workflows; S2, calculating control torque of a main robot and the subordinate robot in the teleoperation system. While the subordinate robot tracks the trajectory of the main robot, the interaction torque between the subordinate robot and the environment is transmitted to the main robot. S3, setting a variable shape virtual fixture; S4, calculating the torque applied by the virtual fixture; S5, introducing the torque of the virtual fixture into the teleoperation system to realize the non-interference coupling in the human-machine workflow. The method provided by the invention facilitates manual operations to be integrated into a non-interfering and undisrupted automatic workflow, and avoids unsafe human contact with a robotic environment, while ensuring intuitive human-computer interaction performance and safety of the system.

### TECHNICAL FIELD

The present disclosure relates to the field of human-computer interaction technology, in particular to a solution of an undisrupted human-computer workflow coupling based on variable virtual fixtures.

### BACKGROUND

A Collaborative Robot (Cobots) refers to a type of robot capable of working safely and efficiently alongside humans within a shared workspace. In contrast to traditional industrial robots, cobots generally exhibit greater flexibility and intelligence, enabling interaction with human operators through sensing and learning capabilities. However, existing cobot systems still face numerous challenges in complex and dynamic working environments, particularly in highly flexible human-robot interaction scenarios. Key issues include operational continuity, seamless workflow integration, and the safety of human-robot collaboration. Biomedical laboratory procedures are typically characterized by high complexity and dynamism, involving extensive manual operations and real-time interventions. These demands present greater challenges to current automated robotic systems, as most existing automated laboratory setups are designed for fully autonomous workflows. For reference, existing technologies can be found in patents with publication numbers CN202411365422.9 and CN202420609105.6, both of which focus on developing automated processes such as precise positioning and sample handling. These systems, however, do not adequately incorporate workflows requiring human intervention. The introduction of human operators into such automated processes tends to disrupt task execution.

Virtual fixtures are computer-generated aids that provide constraints, guidance, or assistance during robotic operations via software algorithms, mimicking the function of physical fixtures. Existing research has proposed a robot-assisted drilling and craniotomy system that operates under manual guidance, dividing the drilling task into two phases: alignment and drilling. Machine learning is employed to recognize the surgeon's intent, enabling the switching of virtual fixtures between phases. In contrast, human-robot interaction workflows in laboratory settings are more standardized compared to surgical procedures. Examples include using a pipette to inject liquid into test tubes within an automated workflow, or retrieving specific samples from a large batch during automated processing. Such operations do not require complex machine learning algorithms for intent recognition. Moreover, machine learning approaches often demand significant computational resources and lack generalizability.

### SUMMARY

The purpose of the present disclosure is to provide a solution of an undisrupted human-computer workflow coupling based on variable virtual fixtures to solve the problems existing in the above background technology.

In order to achieve the above purpose, the present disclosure provides a solution of an undisrupted human-computer workflow coupling based on variable virtual fixtures, including the following steps:
S1, dividing a workflow in a laboratory into a manual operation workflow and an automated workflow, the manual operation workflow avoids a direct contact between an operator and the harmful environment, and adopts a control mode of teleoperation, including a main robot and a subordinate robot;
S2, calculating a control torque of the main robot and the subordinate robot in a teleoperation system, while the subordinate robot tracks the trajectory of the main robot, transmitting an interaction torque between the subordinate robot and the environment to the main robot;
S3, setting up a virtual fixture with a variable shape, a pose of the virtual fixture is updated according to a movement of an object operated in the automatic workflow, and a shape of the virtual fixture is determined according to operation stages, which is used to exert guiding force on the operator who controls the main robot;
S4, calculating the torque applied by the virtual fixture;
S5, introducing the torque of the virtual fixture into the teleoperation system to realize a non-interference coupling in a human-machine workflow.

In some embodiments, in S1, under the influence of an external torque applied by the operator and the environment, the expected main robot motion is determined according to the ideal environmental impedance characteristics

$${M}_{e} ( {q}_{m} ) {q}_{md}^{\cdot \cdot } + {C}_{e} ( {q}_{m} , {q}_{m}^{\cdot } )$$

$${q}_{m d}^{\cdot } + {G}_{m} ( {q}_{m} ) = {τ}_{h} + {τ}_{e} , where {q}_{md} , {q}_{m d}^{\cdot } and {q}_{md}^{\cdot \cdot }$$

denote an expected position, a velocity and an acceleration of the main robot in a joint space, respectively, and qₘ and

$${q}_{m d}^{\cdot }$$

denote a current position and the velocity of the main robot, respectively, Mₑ and Cₑ denote the ideal environmental impedance parameters, Gₘ is a gravity torque, τₕ is a torque applied by the operator to the main robot, τₑ is a torque from the interaction between the robot and the environment, including the torque Tr of the real environment and the guiding torque τ_{vf} of the virtual fixture.

In some embodiments, in S2, according to an error between the current position and an expected position of the main robot, obtaining a control torque of the main robot at this time by a torque controller; due to an influence of communication, there is a high frequency noise in the position information transmitted to the subordinate robot; firstly, obtaining a expected motion of the subordinate robot through a low-pass filter; then, according to an error between the current position and an expected position of the subordinate robot, obtaining the control torque of the subordinate robot by the torque controller, and performing an interaction with the environment; the torque controller is realized by anti-stepping control based on Lyapunov stability criterion; the control torque calculation formulas of the main robot and the subordinate robot are as follows:

$${τ}_{m} = - {μ}_{2} [ {q}_{m}^{\cdot } - {q}_{m d}^{\cdot } + {μ}_{1} ( {q}_{m} - {q}_{m d} ) ] - ( {q}_{m} - {q}_{m d} ) - {τ}_{h} + {C}_{m} [ - {μ}_{1} ( {q}_{m} - {q}_{m d} ) + {q}_{m d}^{\cdot } ] + {M}_{m} [ - {μ}_{1} ( {q}_{m}^{\cdot } - {q}_{m d}^{\cdot } ) + {q}_{m d}^{\cdot \cdot } ] ;$$

$${τ}_{s} = - {μ}_{2}^{′} [ {q}_{s}^{\cdot } - {q}_{s d}^{\cdot } + {μ}_{1}^{′} ( {q}_{s} - {q}_{s d} ) ] - ( {q}_{s} - {q}_{s d} ) - {τ}_{e} + {C}_{s} [ - {μ}_{1}^{′} ( {q}_{s} - {q}_{s d} ) + {q}_{s d}^{\cdot } ] + {M}_{s} [ - {μ}_{1}^{′} ( {q}_{s}^{\cdot } - {q}_{s d}^{\cdot } ) + {q}_{s d}^{\cdot \cdot } ] ;$$

where τₘ and τₛ are the control torques of the main robot and the subordinate robot; qₘ,

$${q}_{m}^{\cdot }$$

and qₛ, qₛ are the positions and velocities of the main robot and subordinate robot; q_{md},

$${q}_{m d}^{\cdot } and {q}_{md}^{\cdot \cdot }$$

are the expected position, velocity and acceleration of the main robot; q_{sd},

$${q}_{s d}^{\cdot } and {q}_{sd}^{\cdot \cdot }$$

are robot's expected position, velocity, acceleration; μ₁, μ₂, μ₁′, μ₂′ are the control parameters of the controller of the main robot and subordinate robot which are greater than zero; Cₘ and Cₛ are a Coriolis force matrix and a centripetal force of the main robot and the subordinate robot; Mₘ and Mₛ are the inertia matrices of the main robot and the subordinate robot.

In some embodiments, in S2, since the interaction force between the force applied by the operator and the real environment is measured by the force sensor, a corresponding dead zone is introduced to reduce an offset and measurement error of the force sensor; when the measured force is lower than a specific threshold, the force is regarded as zero, and impedance characteristic parameters Mₑ and Cₑ of the environment are increased.

In some embodiments, S3, in an actual laboratory human-machine collaboration workflow, a common operation is to use a pipette to extract liquid samples from a running automated workflow, which is divided into two stages: an alignment stage where the pipette is aligned to a specific test tube on a test tube holder and an insertion stage where the pipette are inserted downward for subsequent operations, a variable shape virtual fixture is designed for the two stages; the two variable shapes include: when a working area is large during the alignment stage and the position of the operating object is relatively concentrated, a funnel-shaped virtual fixture is used to limit the working area of the subordinate robot to a range of the test tube holder, it is convenient for the operator to remotely select the test tube required to extract the liquid from the robot in the test tube holder, and ensure that the funnel moves with the movement of an automatic end, after selecting a specific test tube, the operator changes the virtual fixture into a cylindrical shape through a button, which will be generated at a position of the selected test tube, while keeping the working area of the robot consistent with the automatic end of the movement, a direction of the end tool of the robot is limited to align with the test tube.

In some embodiments, the shape of the virtual fixture is switched according to the different task stages; if it is in the alignment stage, the virtual fixture is set to the funnel shape formed by a hyperboloid, and an pose constraint of the subordinate robot is not enabled; if it is in the insertion stage, the virtual fixture is set to be cylindrical, and the pose constraint is enabled.

In some embodiments, in S4, the torque applied by the virtual fixture is calculated through a geometric relationship of the virtual fixture, including:

S41, based on a pose Pose_{vf} of the virtual fixture, that is, an equation of a bottom plane obtained by a center position Pos_{vf}(x_{vf},y_{vf},z_{vf}) and a normal vector n_{vf}(nₓ,n_{y},n_{z}) of the funnel or the bottom circle of the cylinder is as follows:

$${n}_{x} ( x - {x}_{vf} ) + {n}_{y} ( y - {y}_{vf} ) + {n}_{z} ( z - {z}_{vf} ) = 0 ;$$

and then transforming into a form of Ax+By+Cz+D=0, wherein,

$$[ A , B , C , D ] = [ {n}_{x} , {n}_{y} , {n}_{z} , - {n}_{x} {x}_{vf} - {n}_{y} {y}_{vf} - {n}_{z} {z}_{vf} ] ;$$

S42, calculating a distance from a position Pos_{tcp}(x_{tcp},y_{tcp},z_{tcp}) of a robot's current tool center point to the bottom plane:

$${d}_{p} = \frac{\vert {Ax}_{tcp} + {By}_{tcp} + {Cz}_{tcp} + D \vert}{\sqrt{{A}^{2} + {B}^{2} + {C}^{2}}}$$

S43, calculating a center position of an inner plane of the virtual fixture from which the robot is currently located:

$${Pos}_{c} = {Pos}_{vf} + {d}_{p} {n}_{vf} ;$$

S44, determining a radius of a current planar circle based on the shape of the virtual fixture:

$${r}_{c} = \vert {r}_{b} \sqrt{1 + \frac{{d}_{p}^{2}}{{( {k}_{vf} {r}_{c} )}^{2}}} \vert ;$$

if it is in a hyperbolic funnel shape, a radius is r_{c}; if it is in a cylindrical shape, the radius is a predetermined bottom radius r_{b}, where k_{vf} determines the opening size of the funnel;

S45, computing a force direction vector:

$$forceVec = {Pos}_{c} - {Pos}_{tcp} ;$$

S46, calculating an applied force of the virtual fixture based on a spring damping model:

$${F}_{vf} = K * forceVec - D * {Vel}_{tcp} ;$$

where K and D denote the spring damping coefficients of the predetermined virtual fixture, Vel_{tcp} is a velocity of the tool center point.

In some embodiments, if the pose constraint is enabled, the fixture of the pose of the end tool of the current subordinate robot and the direction vector n_{vf} of the predetermined virtual fixture are calculated, and then the torque applied to the subordinate robot is calculated by the same method as S46, the torque is combined with the force calculated in S46 to obtain Wrench_{vf}; τ_{vf} is calculated through a robot force-jacobian:

$${τ}_{vf} = {J}^{T} * {Wrench}_{vf} ;$$

where J is a Jacobian matrix for the robot.

Therefore, the present disclosure adopts the above-mentioned solution of undisrupted human-machine workflow coupling based on variable virtual fixture, which has the following beneficial effects:
(1) The operator and the harmful environment are separated by the teleoperation control framework, by introducing the virtual fixture technology with a variable shape, the workflow of manual operation is integrated without interfering with the existing automated workflow, and the undisrupted human-machine workflow coupling system is realized, which effectively improves the continuity and operation efficiency of human-machine collaboration.
(2) The variable virtual fixture can dynamically adjust its shape and function according to the different stages of the workflow to adapt to the highly complex and dynamic operating requirements in biomedical laboratories, which enables the robot system to respond flexibly in a variety of experimental environments, significantly improving its scope of application and practicality.
(3) This method is a universal teleoperation robot solution, which is suitable for a variety of different biomedical experimental processes, and has good scalability and adaptability, it enables the system to meet the specific needs of different laboratories and promotes the wide application of robot technology in intelligent biomedical laboratories.

The following is a further detailed description of the technical scheme of the present disclosure through drawings and implementation examples.

### BRIEF DESCRIPTION OF THE DRAWINGS

FIG. 1 is a block diagram of the teleoperation control system solution of the undisrupted human-computer workflow coupling based on variable virtual fixtures of the present disclosure.

FIG. 2 is a funnel-shaped virtual fixture diagram in the alignment stage of the present disclosure.

FIG. 3 is a schematic diagram of the cylindrical virtual fixture in the insertion stage of the present disclosure;

FIG. 4 is a schematic diagram of the geometric relationship of the virtual fixture of the present disclosure.

### DETAILED DESCRIPTION OF THE EMBODIMENTS

The following detailed description of the embodiment of the present disclosure provided in the accompanying diagram is not intended to limit the scope of the present disclosure requiring protection, but merely indicates the selected embodiment of the present disclosure. Based on the embodiments in this present disclosure, all other embodiments obtained by ordinary technicians in this field without making creative labor belong to the scope of protection of this present disclosure.

A solution of the undisrupted human-computer workflow coupling based on variable virtual fixtures includes the following steps:

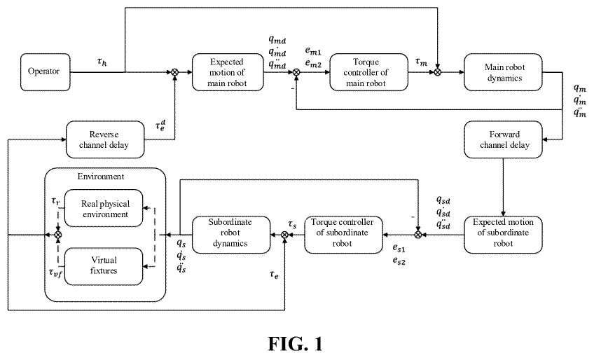

S1, the workflow in a laboratory is divided into a manual operation workflow and an automated workflow, the manual operation workflow avoids the direct contact between the operator and the harmful environment, and adopts a control mode of teleoperation, as shown in FIG. 1, including a main robot and a subordinate robot. Under the influence of the external torque applied by the operator and the environment, the expected main robot motion is determined according to the ideal environmental impedance characteristics

$${M}_{e} ( {q}_{m} ) {q}_{md}^{\cdot \cdot } + {C}_{e} ( {q}_{m} , {q}_{md}^{\cdot } ) {q}_{md}^{\cdot } + {G}_{m} ( {q}_{m} ) = {τ}_{h} + {τ}_{e} ,$$

$$where {q}_{md} , {q}_{md}^{\cdot } and {q}_{md}^{\cdot \cdot }$$

denote the expected position, velocity and acceleration of the main robot in a joint space, respectively, and qₘ and qₘ denote the current position and velocity of the main robot, respectively, Mₑ and Cₑ denote the ideal environmental impedance parameters, Gₘ is a gravity torque, τₕ is a torque applied by the operator to the main robot, τₑ is a torque from the interaction between the robot and the environment, including the torque τᵣ of the real environment and the guiding torque τ_{vf} of the virtual fixture.

S2, according to the error between the current position and the expected position of the main robot, the control torque of the main robot is obtained by the torque controller. Due to the influence of communication, there is a high frequency noise in the position information transmitted to the subordinate robot; firstly, a expected motion of the subordinate robot is obtained through a low-pass filter; then, according to the error between the current position and the expected position of the subordinate robot, the control torque of the subordinate robot is obtained by the torque controller, and the interaction with the environment is performed; where the torque controller is realized by anti-stepping control based on Lyapunov stability criterion; the control torque calculation formulas of the main robot and the subordinate robot are as follows:

$${τ}_{m} = - {μ}_{2} [ {q}_{m} - {q}_{md}^{\cdot } + {μ}_{1} ( {q}_{m} - {q}_{md} ) ] - ( {q}_{m} - {q}_{md} ) - {τ}_{h} + {C}_{m} [ - {μ}_{1} ( {q}_{m} - {q}_{md} ) + {q}_{md}^{\cdot } ] + {M}_{m} [ - {μ}_{1} ( {q}_{m} - {q}_{md}^{\cdot } ) + {q}_{md}^{\cdot \cdot } ] ;$$

$${τ}_{s} = - {μ}_{2}^{′} [ {q}_{s} - {q}_{sd}^{\cdot } + {μ}_{1}^{′} ( {q}_{s} - {q}_{sd} ) ] - ( {q}_{s} - {q}_{sd} ) - {τ}_{e} + {C}_{s} [ - {μ}_{1}^{′} ( {q}_{s} - {q}_{sd} ) + {q}_{sd}^{\cdot } ] + {M}_{s} [ - {μ}_{1}^{′} ( {q}_{s} - {q}_{sd}^{\cdot } ) + {q}_{sd}^{\cdot \cdot } ] ;$$

where τₘ and τₛ are the control torques of the main robot and the subordinate robot; qₘ,

$${q}_{m}^{\cdot }$$

and qₛ, qₛ are the positions and velocities of the main robot and subordinate robot; q_{md},

$${q}_{md}^{\cdot } and {q}_{md}^{\cdot \cdot }$$

are the expected position, velocity and acceleration of the main robot; q_{sd},

$${q}_{sd}^{\cdot } and {q}_{sd}^{\cdot \cdot }$$

are robot's expected position, velocity, acceleration; μ₁, μ₂, μ₁′, μ₂′ are the control parameters of the controller of the main robot and subordinate robot which are greater than zero; Cₘ and Cₛ are a Coriolis force matrix and a centripetal force of the main robot and the subordinate robot; Mₘ and Mₛ are the inertia matrices of the main robot and the subordinate robot.

In addition, since the interaction force between the force applied by the operator and the real environment is measured by the force sensor, a corresponding dead zone is introduced to reduce an offset and measurement error of the force sensor; when the measured force is lower than a specific threshold, the force is regarded as zero, and impedance characteristic parameters Mₑ and Cₑ of the environment are increased.

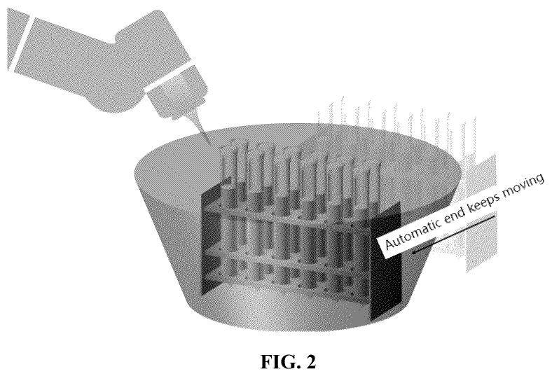

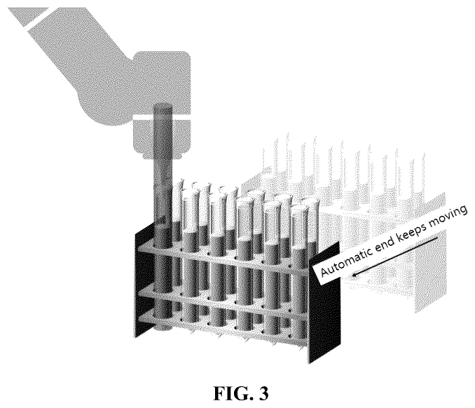

S3, in the actual laboratory human-machine collaboration workflow, a common operation is to use a pipette to extract liquid samples from the running automated workflow, in this embodiment, this process is divided into two stages: an alignment stage where the pipette is aligned to a specific test tube on a test tube holder and an insertion stage where the pipette are inserted downward for subsequent operations, therefore, a variable shape virtual fixture is designed for the two stages, and the pose of the virtual fixture will be updated with the movement of the object operated in the automated workflow, as shown in FIG. 2-FIG. 3; the two variable shapes include: When the working area is large during the alignment stage and the position of the operating object is relatively concentrated, a funnel-shaped virtual fixture is used to limit the working area of the subordinate robot to a range of the test tube holder, it is convenient for the operator to remotely select the test tube required to extract the liquid from the robot in the test tube holder, and ensure that the funnel moves with the movement of the automatic end, after selecting a specific test tube, the operator changes the virtual fixture into a cylindrical shape through a button, which will be generated at the position of the selected test tube, while keeping the working area of the robot consistent with the automatic end of the movement, the direction of the end tool of the robot is limited to align with the test tube.

The main purpose of the virtual fixture is to apply a guiding force to the operator who controls the main robot through the algorithm to ensure that the subordinate robot's workspace of the clamping tool can track the movement of the automated workflow, so that the manual operation workflow and the automated workflow can be coupled together without interference.

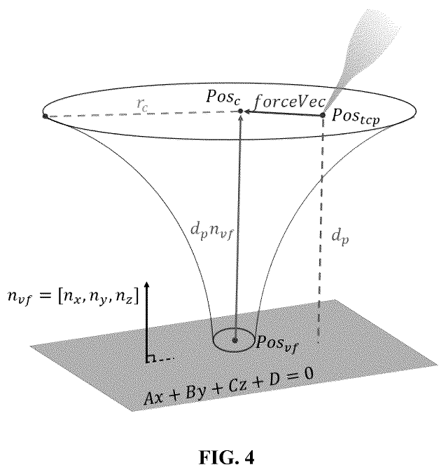

S4, the torque applied by the virtual fixture is calculated through the geometric relationship of the virtual fixture. As shown in FIG. 4, the pose of the virtual fixture Pos e_{vf}, that is, the center position Pos_{vf} and normal vector n_{vf} of the funnel or the bottom circle of the cylinder, can be dynamically adjusted according to the pose of the automation end at this time. There are many ways to obtain the motion pose of the automation end: for example, the depth camera is used to identify the two-dimensional code attached to the automation end through computer vision; or the coordinate system of the automation end and the coordinate system of the robot in the interactive end teleoperation system are calibrated in advance; since the motion trajectory of the automation end is pre-programmed, the motion trajectory can be directly converted to the coordinate system of the teleoperation system through the calibrated positional relationship; the radius of the base circle on the bottom surface is determined by the size of the required working area, such as the radius of the test tube, the radius of the cutting surface of the test tube frame, etc. According to the different task stages, the shape of the virtual fixture can be switched. In the alignment stage, the virtual fixture is set to a funnel shape formed by the hyperboloid, and the pose constraint of the subordinate robot is not enabled; in the insertion stage, the virtual fixture is set to be cylindrical, and the pose constraint is enabled; the calculation process is as follows:

S41, based on the pose Pose_{vf} of the virtual fixture, that is, the equation of the bottom plane obtained by the center position Pos_{vf}(x_{vf},y_{vf},z_{vf}) and the normal vector n_{vf}(nₓ,n_{y},n_{z}) of the funnel or the bottom circle of the cylinder is as follows:

$${n}_{x} ( x - {x}_{vf} ) + {n}_{y} ( y - {y}_{vf} ) + {n}_{z} ( z - {z}_{vf} ) = 0 ;$$

and then it is transformed into a form of Ax+By+Cz+D=0, wherein,

$$[ A , B , C , D ] = [ {n}_{x} , {n}_{y} , {n}_{z} , - {n}_{x} {x}_{vf} - {n}_{y} {y}_{vf} - {n}_{z} {z}_{vf} ] ;$$

S42, the distance from the position Pos_{tcp}(x_{tcp},y_{tcp},z_{tcp}) of the robot's current tool center point(TCP) is calculated to the bottom plane:

$${d}_{p} = \frac{\vert {Ax}_{tcp} + {By}_{tcp} + {Cz}_{tcp} + D \vert}{\sqrt{{A}^{2} + {B}^{2} + {C}^{2}}}$$

S43, the center position of the inner plane of the virtual fixture from which the robot is currently located is calculated:

$${Pos}_{c} = {Pos}_{vf} + {d}_{p} {n}_{vf} ;$$

S44, the radius of the current planar circle is determined based on the shape of the virtual fixture:

$${r}_{c} = \vert {r}_{b} \sqrt{1 + \frac{{d}_{p}^{2}}{{( {k}_{vf} {r}_{c} )}^{2}}} \vert ;$$

if it is in a hyperbolic funnel shape, the radius is r_{c}; if it is in a cylindrical shape, the radius is a predetermined bottom radius r_{b}, where k_{vf} determines the opening size of the funnel;

S45, computing a force direction vector:

$$forceVec = {Pos}_{c} - {Pos}_{tcp} ;$$

S46, calculating an applied force of the virtual fixture based on a spring-damping model:

$${F}_{vf} = K * forceVec - D * {Vel}_{tcp} ;$$

where K and D denote the spring damping coefficients of the predetermined virtual fixture, Vel_{tcp} is a velocity of the tool center point.

S47, if the pose constraint is enabled, the fixture of the pose of the end tool of the current subordinate robot and the direction vector n_{vf} of the predetermined virtual fixture are calculated, and then the torque applied to the subordinate robot is calculated by the same method as S46, the torque is combined with the force calculated in S46 to obtain Wrench_{vf};

S47, r_{vf} is calculated through a robot force-jacobian:

$${τ}_{vf} = {J}^{T} * {Wrench}_{vf} ;$$

where J is a Jacobian matrix for the robot.

In principle, the virtual fixture in this embodiment can be replaced by various geometric shapes, such as a vertebral body, a cuboid, and so on. It only needs to be replaced by the corresponding geometric figure when calculating the force vector part. In order to meet the practical application background of this implementation example, the virtual fixture in this present disclosure adopts two shapes: a funnel shape and a cylindrical shape.

S5, the torque of the virtual fixture is applied to the subordinate robot to realize the non-interference coupling in the human-machine workflow. Without stopping the automated workflow, the teleoperation system with variable virtual fixtures is used to provide the operator with guidance that is synchronized with the movement of the automated workflow.

Therefore, the present disclosure adopts the above-mentioned solution of the undisrupted human-computer workflow coupling based on variable virtual fixtures, and realizes a solution that seamlessly integrates manual operation workflow into the system on the basis of not interfering with and interrupting various existing laboratory automation workflows. Meanwhile, the system can avoid the operator's direct contact with the harmful environment, and ensure that the system has excellent human-computer interaction performance and high safety. The operator controls the main robot through the teleoperation terminal when it is far away from the harmful environment, so as to command the subordinate robot to perform specific operations and interact with the automated workflow. The virtual fixture can dynamically adjust its shape according to different workflow stages, and transmit the motion of the automated workflow to the operator synchronously by force guidance, so as to realize the continuity and fluency of human-machine cooperation without interfering with the existing automated workflow. The control algorithm used in the system has a small computational burden, which ensures its universality and real-time performance in various laboratory environments and can adapt to diverse operational requirements.

Finally, it should be explained that the above embodiments are only used to explain the technical scheme of the present disclosure rather than restrict it. Although the present disclosure is described in detail with reference to the better embodiment, the ordinary technical personnel in this field should understand that they can still modify or replace the technical scheme of the present disclosure, and these modifications or equivalent substitutions cannot make the modified technical scheme out of the spirit and scope of the technical scheme of the present disclosure.

What is claimed is:

1. A method of coordinating human-computer workflows based on variable virtual fixtures, comprising the following steps:
S1, dividing a workflow in a laboratory into a manual operation workflow and an automated workflow, wherein the manual operation workflow avoids direct contact between an operator and a hazardous environment, and wherein the manual operation workflow is a control mode of teleoperation of a main robot and a subordinate robot;
S2, calculating a control torque of the main robot and the subordinate robot in a teleoperation system, while the subordinate robot tracks the trajectory of the main robot, transmitting an interaction torque between the subordinate robot and the environment to the main robot;
S3, setting up a virtual fixture with a variable shape, wherein a pose of the virtual fixture is updated according to a movement of an object operated in the automatic workflow, and a shape of the virtual fixture is determined according to operation stages, which is used to exert guiding force on the operator who controls the main robot;
S4, calculating the torque applied by the virtual fixture;
S5, introducing the torque of the virtual fixture into the teleoperation system to realize a non-interference coupling in a human-machine workflow;
wherein in S2, according to an error between the current position and an expected position of the main robot, calculating a control torque of the main robot at this time by a torque controller; wherein, due to an influence of communication, there is a high frequency noise in the position information transmitted to the subordinate robot; firstly, obtaining a expected motion of the subordinate robot through a low-pass filter; then, according to an error between the current position and a expected position of the subordinate robot, obtaining the control torque of the subordinate robot by the torque controller, and performing an interaction with the environment; the torque controller is realized by anti-stepping control based on Lyapunov stability criterion; the control torque calculation formulas of the main robot and the subordinate robot are as follows:
$${τ}_{m} = - {μ}_{2} [ {q}_{m} - {q}_{md}^{\cdot } + {μ}_{1} ( {q}_{m} - {q}_{md} ) ] - ( {q}_{m} - {q}_{md} ) - {τ}_{h} + {C}_{m} [ - {μ}_{1} ( {q}_{m} - {q}_{md} ) + {q}_{md}^{\cdot } ] + {M}_{m} [ - {μ}_{1} ( {q}_{m} - {q}_{md}^{\cdot } ) + {q}_{md}^{\cdot \cdot } ] ;$$
$${τ}_{s} = - {μ}_{2}^{′} [ {q}_{s} - {q}_{sd}^{\cdot } + {μ}_{1}^{′} ( {q}_{s} - {q}_{sd} ) ] - ( {q}_{s} - {q}_{sd} ) - {τ}_{e} + {C}_{s} [ - {μ}_{1}^{′} ( {q}_{s} - {q}_{sd} ) + {q}_{sd}^{\cdot } ] + {M}_{s} [ - {μ}_{1}^{′} ( {q}_{s} - {q}_{sd}^{\cdot } ) + {q}_{sd}^{\cdot \cdot } ] ;$$
where τₘ and τₛ are the control torques of the main robot and the subordinate robot; qₘ,
$${q}_{m}^{\cdot }$$
and qₛ, qₛ are the positions and velocities of the main robot and subordinate robot; q_{md},
$${q}_{md}^{\cdot } and {q}_{md}^{\cdot \cdot }$$
are the expected position, velocity and acceleration of the main robot; q_{sd},
$${q}_{sd}^{\cdot } and {q}_{sd}^{\cdot \cdot }$$
are robot's expected position, velocity, acceleration; μ₁, μ₂, μ₁′, μ₂′ are the control parameters of the controller of the main robot and subordinate robot which are greater than zero; Cₘ and Cₛ are a Coriolis force matrix and a centripetal force of the main robot and the subordinate robot; Mₘ and Mₛ are the inertia matrices of the main robot and the subordinate robot; and
wherein in S3, in the laboratory human-machine collaboration workflow, a pipette is used to extract liquid samples from a running automated workflow, which is divided into two stages: an alignment stage where the pipette is aligned to a specific test tube on a test tube holder and an insertion stage where the pipette is inserted downward for subsequent operations, wherein the variable shape virtual fixture is designed for the two stages and the two variable shapes include: when a working area is large during the alignment stage and the position of the operating object is relatively concentrated, a funnel-shaped virtual fixture is used to limit the working area of the subordinate robot to a range of the test tube holder, and is configured to allow the operator to remotely select the test tube required to extract the liquid from the robot in the test tube holder, and ensure that the funnel moves with the movement of an automatic end; and wherein, after selecting a specific test tube, the operator changes the virtual fixture into a cylindrical shape through a button, which will be generated at a position of the selected test tube, while keeping the working area of the robot consistent with the automatic end of the movement, a direction of the end tool of the robot is limited to align with the test tube.

2. The method of coordinating human-computer workflows based on variable virtual fixtures according to claim 1, wherein in S1, under the influence of an external torque applied by the operator and the environment, the expected main robot motion is determined according to an ideal environmental impedance characteristics
$${M}_{e} ( {q}_{m} ) {q}_{md}^{\cdot \cdot } + {C}_{e} ( {q}_{m} , {q}_{m}^{\cdot } ) {q}_{md}^{\cdot } + {G}_{m} ( {q}_{m} ) = {τ}_{h} + {τ}_{e} ,$$
$$where {q}_{md} , {q}_{md}^{\cdot } and {q}_{md}^{\cdot \cdot }$$
denote an expected position, a velocity and an acceleration of the main robot in a joint space, respectively, and qₘ and
$${q}_{m}^{\cdot }$$
denote a current position and the velocity of the main robot, respectively, Mₑ and Cₑ denote the ideal environmental impedance parameters, Gₘ is a gravity torque, τₕ is a torque applied by the operator to the main robot, τₑ is a torque from the interaction between the robot and the environment, comprising the torque τᵣ of the real environment and the guiding torque τ_{vf} of the virtual fixture.

3. The method of coordinating human-computer workflows based on variable virtual fixtures according to claim 1, wherein in S2, since the interaction force between the force applied by the operator and the real environment is measured by a force sensor, a corresponding dead zone is introduced to reduce an offset and measurement error of the force sensor; when the measured force is lower than a specific threshold, the force is regarded as zero, and impedance characteristic parameters Mₑ and Cₑ of the environment are increased.

4. The method of coordinating human-computer workflows based on variable virtual fixtures according to claim 1, wherein the shape of the virtual fixture is switched according to the different task stages; if it is in the alignment stage, the virtual fixture is set to the funnel shape formed by a hyperboloid, and a pose constraint of the subordinate robot is not enabled; if it is in the insertion stage, the virtual fixture is set to be cylindrical, and the pose constraint is enabled.

5. The method of coordinating human-computer workflows based on variable virtual fixtures according to claim 1, wherein in S4, the torque applied by the virtual fixture is calculated through a geometric relationship of the virtual fixture, comprising:
S41, based on a pose Pose_{vf} of the virtual fixture, that is, an equation of a bottom plane obtained by a center position Pos_{vf}(x_{vf},y_{vf},z_{vf}) and a normal vector n_{vf}(nₓ,n_{y},n_{z}) of the funnel or the bottom circle of the cylinder is as follows:
$${n}_{x} ( x - {x}_{vf} ) + {n}_{y} ( y - {y}_{vf} ) + {n}_{z} ( z - {z}_{vf} ) = 0 ;$$
and then transforming into a form of Ax+By+Cz+D=0, wherein
$$[ A , B , C , D ] = [ {n}_{x} , {n}_{y} , {n}_{z} , - {n}_{x} {x}_{vf} - {n}_{y} {y}_{vf} - {n}_{z} {z}_{vf} ] ;$$
S42, calculating a distance from a position Pos_{tcp}(x_{tcp},y_{tcp},z_{tcp}) of a robot's current tool center point to the bottom plane:
$${d}_{p} = \frac{\vert {Ax}_{tcp} + {By}_{tcp} + {Cz}_{tcp} + D \vert}{\sqrt{{A}^{2} + {B}^{2} + {C}^{2}}}$$
S43, calculating a center position of an inner plane of the virtual fixture from which the robot is currently located:
$${Pos}_{c} = {Pos}_{vf} + {d}_{p} {n}_{vf} ;$$
S44, determining a radius of a current planar circle based on the shape of the virtual fixture:
$${r}_{c} = \vert {r}_{b} \sqrt{1 + \frac{{d}_{p}^{2}}{{( {k}_{vf} {r}_{c} )}^{2}}} \vert ;$$
if it is in a hyperbolic funnel shape, a radius is r_{c}; if it is in a cylindrical shape, the radius is a predetermined bottom radius r_{b}, where k_{vf} determines the opening size of the funnel;
S45, computing a force direction vector:
$$forceVec = {Pos}_{c} - {Pos}_{tcp} ;$$
S46, calculating an applied force of the virtual fixture based on a spring-damping model:
$${F}_{vf} = K * D * {Vel}_{tcp} ;$$
where K and D denote the spring damping coefficients of the predetermined virtual fixture, Vel_{tcp} is a velocity of the tool center point.

6. The method of coordinating human-computer workflows based on variable virtual fixtures according to claim 5, wherein if the pose constraint is enabled, the fixture of the pose of the end tool of the current subordinate robot and the direction vector n_{vf} of the predetermined virtual fixture are calculated, and then the torque applied to the subordinate robot is calculated by the same method as S46, the torque is combined with the force calculated in S46 to obtain Wrench_{vf};
τ_{vf} is calculated through a robot force-jacobian:
$${τ}_{vf} = {J}^{T} * {Wrench}_{vf} ;$$
where J is a Jacobian matrix for the robot.
